(19) United States
(12) Patent Application Publication
(10) Pub. No.: US 2026/0195174 A1
(43) Pub. Date: Jul. 9, 2026

(54) System and Method for High-Throughput Execution of Deep-Learning Workloads

(71) Applicant: CentML AI Inc., Toronto (CA)

(72) Inventors: Qidong SU, Toronto (CA); Wei ZHAO, Stanford, CA (US); Xin LI, Toronto (CA); Muralidhar ANDOORVEEDU, Mississauga (CA); Xinyang SONG, Richmond Hill (CA); Chenhao JIANG, Toronto (CA); Zhanda ZHU, Toronto (CA); Christina GIANNOULA, Toronto (ON); Gennady PEKHIMENKO, Oakville (CA)

(73) Assignee: CentML AI Inc., Toronto (CA)

(21) Appl. No.: 19/444,721

(22) Filed: Jan. 9, 2026

Related U.S. Application Data
(60) Provisional application No. 63/743,308, filed on Jan. 9, 2025.

(51) Int. Cl. G06F 9/48; G06F 9/50

(52) U.S. Cl. CPC G06F 9/4881; G06F 9/5077

(57) ABSTRACT

A system and method of executing a deep-learning workload are provided. The method includes selecting at least one parallelization strategy for a first processing stage of the workload, selecting at least one different parallelization strategy for a second processing stage of the workload, and switching between the different strategies used for the first and second processing stages by reconfiguring a partitioning of the deep-learning workload across computing resources.

### CROSS-REFERENCE TO RELATED APPLICATION(S)

This application claims priority to U.S. Provisional Patent Application No. 63/743,308 filed on Jan. 9, 2025, the entire contents of which are incorporated herein by reference.

### TECHNICAL FIELD

The following generally relates to execution of deep-learning workloads, including distributed deep learning tasks such as Large Language Model (LLM) inference, and in particular relates to systems and methods for performing high-throughput execution of such workloads having time-varying compute characteristics.

### BACKGROUND

Deep-learning workloads encompass a broad class of computational tasks executed using deep neural network models across distributed computing resources. One example of such distributed deep-learning workloads is Large Language Models (LLMs). LLMs, such as the LLaMA (Touvron et al., 2023a) and GPT (Achiam et al., 2023) families, have demonstrated exceptional performance across a wide range of tasks. Beyond their prevalent use in interactive applications like chatbots (OpenAI, 2024), LLMs are also gaining high interest in throughput-oriented offline inference workloads such as information extraction (Narayan et al., 2022), database querying (Liu et al., 2024), and knowledge graph processing (Edge et al., 2024). Unlike interactive applications where low latency is crucial, these offline inference tasks prioritize high throughput over response time. These offline inference workloads are widely adopted in industry (Kamsetty et al., 2023; Yu et al., 2024; Dell Technologies, 2024; Chan et al., 2024), leading MLPerf® to develop benchmarks specifically for them (MLCommons, 2024).

As LLMs often exceed the memory capacity of individual GPUs, parallelization can be important for their deployment (Ben-Nun & Hoefler, 2019; Shoeybi et al., 2019). Several parallelization strategies, including tensor parallelism (Shoeybi et al., 2019) and pipeline parallelism (Narayanan et al., 2019; Huang et al., 2019), have been proposed, each presenting distinct trade-offs in memory efficiency, inter-device communication, and computational efficiency. Tensor parallelism distributes model weights across devices but can suffer from high communication costs due to frequent all-reduce operations at each layer (Pope et al., 2023; Chang et al., 2024). The communication costs become particularly severe in systems connected via Peripheral Component Interconnect Express (PCIe) (Dell Technologies, 2023) or with partial high-speed connections (NVIDIA Corporation, 2020). In contrast, pipeline parallelism partitions the model into sequential stages, reducing inter-device communication by passing only activations between them. However, to enable pipelining, each data batch needs to be divided into micro-batches, leading to extra execution overhead, since every micro-batch repeatedly loads weights into the compute units (see Section 2.2.1 below for details).

While numerous studies have proposed methods to optimize parallelization strategies for LLMs (Miao et al., 2023; Kwon et al., 2023; Li et al., 2023; Pope et al., 2023), prior works typically rely on a single, static configuration throughout the entire generation process.

### SUMMARY

It has been found that the above-noted one-size-fits-all approach is often inefficient for throughput-oriented multi-stage deep learning tasks, such as LLM inference because it fails to leverage the distinct patterns between the various stages of the workloads, such as in LLM generation: the prefill stage, where the input sequence is processed at once to produce the initial token, and the decode stage, where subsequent tokens are generated sequentially based on prior tokens. These stages can exhibit fundamentally different computational characteristics (Yuan et al., 2024). For example, during the prefill stage, multiple tokens from the input prompt are processed simultaneously, making computation and communication the dominant contributors to runtime. In contrast, the decode stage processes one token at a time for each sequence, increasing the relative time spent on weight transfer. This difference indicates that the optimal parallelization strategy for each stage may also vary.

In the present disclosure, a system is provided that may operate to improve execution, such as inference, efficiency for offline, throughput-oriented LLM inference workloads or any deep-learning workloads that have time-varying compute characteristics.

In one aspect, there is provided a method of executing a deep learning workload, the method comprising: selecting at least one parallelization strategy for a first processing stage of the deep learning workload; selecting at least one different parallelization strategy for a second processing stage of the deep learning workload; and switching between the different parallelization strategies used for the first processing stage and the second processing stage by reconfiguring a partitioning of the deep learning workload across computing resources.

In certain example embodiments, reconfiguring the partitioning of the deep learning workload includes dynamically re-sharding one or more model parameters across the computing resources.

In certain example embodiments, the method includes using tiered key-value (KV) cache buffering to reduce re-sharding overheads.

In certain example embodiments, using tiered key-value cache includes: buffering key-value cache data in a tiered memory hierarchy including a primary storage and an auxiliary storage; and controlling the switching between the parallelization strategies based on a storage of the key-value cache in the auxiliary storage.

In certain example embodiments, the auxiliary storage is a shared memory on a secondary device.

In certain example embodiments, the deep-learning workload includes large language model (LLM) inference.

In certain embodiments, the first processing stage is prefilling stage of LLM inference and the at least one parallelization strategy selected for the first processing stage is pipeline parallelism, and the second processing stage is decoding stage and the at least one different parallelization strategy for the second processing stage is tensor parallelism.

In certain example embodiments, the parallelization strategies utilize multiple computation resources, including any one or more of graphics processing units (GPUs), CPUs, or accelerators.

In certain example embodiments, switching between the different parallelization strategies includes applying a transition-minimizing scheduling policy.

In certain example embodiments, the transition minimizing scheduling policy is configured to control the switching between the first and second processing stages to occur when a key-value (KV) cache in the auxiliary storage is either full or empty.

In certain example embodiments, the method is performed by a deep learning workload execution engine comprising a single-scheduler, multi-worker design, and the single scheduler manages generation requests, organizes the generation requests into batches, and sends instructions to a plurality of workers.

In certain example embodiments, the method includes, during execution of the deep-learning workload, using an asynchronous pipeline to overlap KV cache transfer with ongoing computation.

In certain example embodiments, the deep-learning workload includes one or more time-varying compute characteristics.

In another aspect, there is provided a computer readable medium storing computer-executable instructions for performing the method.

In another aspect, there is provided a deep learning workload execution engine comprising a processor and memory, the memory storing computer-executable instructions that, when executed by the processor, cause the engine to perform the steps of: selecting at least one parallelization strategy for a first processing stage of the deep learning workload; selecting at least one different parallelization strategy for a second processing stage of the deep learning workload; and switching between the different parallelization strategies used for the first processing stage and the second processing stage by reconfiguring a partitioning of the deep-learning workload across computing resources.

In certain example embodiments, the engine includes an interconnected and distributed configuration.

### BRIEF DESCRIPTION OF THE DRAWINGS

Embodiments will now be described with reference to the appended drawings wherein:

FIGS. 1A and 1B illustrate a breakdown of execution time for multiple stages, such as prefill and decode stages for an example distributed deep learning workload, such as LLM inference.

FIG. 2 illustrates an example of a computing environment in which an example deep learning workload execution engine is deployed.

FIG. 3 illustrates an example of a computing device that may be utilized to implement the example deep learning workload execution engine.

FIGS. 4A, 4B and 4C illustrate different scheduling policies considering transition overhead.

FIG. 5 illustrates different effects of tensor and pipeline parallelisms on prefilling and decoding stages.

FIG. 6 provides an example of spatially disaggregating prefilling and decoding stages with a restricted search space.

FIG. 7 illustrates model weights and Key-Value (KV) cache that needs to be re-sharded when switching between different parallelization strategies.

FIG. 8 illustrates tiered KV cache buffering and transition-minimizing schedules, showing a change of KV cache occupancy.

FIG. 9 illustrates KV cache re-sharding as completed during swapping to leverage CPU shared memory.

FIG. 10 illustrates an asynchronous pipeline using the example deep-learning workload execution engine.

FIGS. 11A and 11B illustrate input and output length distributions of datasets.

FIGS. 12A and 12B illustrate end-to-end throughput comparisons on PCIe systems.

FIG. 13 illustrates throughput comparison on A100.

FIG. 14 illustrates a speedup breakdown.

FIG. 15 illustrates the throughput of various parallelization strategies with different ratios between out and input lengths.

FIG. 16 illustrates the projected throughput of various parallelization strategies with different inter-connection bandwidths.

FIG. 17 provides a comparison between measure decoding throughput and the predicted value given by an analytical model.

FIG. 18 shows how data parallelism affects the decoding throughput.

### DETAILED DESCRIPTION

### 1. Technical Context

### 1.1. LLM Inference

Transformer Architecture: Modern large language models (LLM) are based on the transformer architecture (Vaswani et al., 2017), which typically comprises of multiple identical decoder layers (OpenAI, 2024). Each layer includes several linear layers and an attention layer. The weights of the linear layers account for the majority of the model's parameters.

Auto-regressive Generation: LLM inference follows an auto-regressive paradigm (Bengio et al., 2000), which takes an input prompt and generates a sequence of output tokens. This process is divided into two stages: prefilling, which processes the input tokens, and decoding, which generates a token per step. These stages exhibit distinct computational properties (Zhong et al., 2024; Yuan et al., 2024). Prefilling processes the prompts, which are typically hundreds to thousands of tokens long. The computation and communication costs, both of which scale with the number of tokens, dominate the runtime during this stage. Since the cost of loading weights is amortized over a larger set of tokens, the overall performance is primarily bound by compute and/or communication. In contrast, decoding processes only the newly generated tokens in each auto-regressive step and has comparatively smaller computation in each step. Therefore, the cost for loading the weight data from off-chip memory to computation units has a relatively higher percentage. In each generation step, the intermediate tensors key (K) and value (V) in each attention operator can be cached for reuse in the future generation, which is called the Key-value cache (KV cache) (Pope et al., 2023). While being able to accelerate computation, it occupies a substantial amount of GPU memory, which is proportional to the total number of tokens.

### 1.2. LLM Inference Optimization

Parallelism: As the size of LLMs grows, the memory capacity on a single graphic processing unit GPU becomes insufficient. Consequently, various techniques are developed to partition models onto multiple GPUs (Zheng et al., 2022). These parallelization strategies can be classified as (1) inter-operator, which places different operators or layers across multiple GPUs, overlapping them with pipelining (known as Pipeline parallelism, PP) (Huang et al., 2019; Narayanan et al., 2019; Li et al., 2023), and (2) intra-operator, which partitions different dimensions of tensors involved in computation, including data parallelism (Srivatsa et al., 2024), tensor parallelism (Shoeybi et al., 2019), etc. Data parallelism duplicates models on different devices and dispatches requests among them. Tensor parallelism shards model weights and each device performs a portion of the computation, then aggregates these partial results to produce the final output.

Batching: Batching more tokens in a single forward pass increases inference efficiency by, for example, amortizing the time required to load model weights (Sheng et al., 2023; Fang et al., 2021). However, its effectiveness differs between the prefilling and decoding stages (Yuan et al., 2024; He & Zhai, 2024; Agrawal et al., 2023). In decoding, where weight-loading overhead occupies a larger portion of the runtime, batching significantly boosts throughput by effectively amortizing this overhead. Conversely, in the prefilling stage, batching has a less pronounced impact since the token count in input prompts is generally sufficient to keep the process compute-bound. Overall, larger batch sizes yield higher throughput, though the maximum batch size is limited by available GPU memory, as it requires additional space for activations and the KV cache.

Continuous Batching and Scheduling: Continuous batching is an important optimization for throughput-oriented LLM inference (Yu et al., 2022; Kwon et al., 2023). By batching multiple sequences at the token level, it allows the system to onboard new sequences and clear the KV cache of completed sequences at any generation step. This approach enables prefill-prioritizing scheduling, which removes sequences as they finish, frees up their KV cache, and eagerly schedules the prefilling of new sequences whenever GPU memory becomes available. This strategy maximizes the number of concurrent sequences being processed, resulting in higher throughput. Another alternative is to use decode prioritizing scheduling, which minimizes the frequency of transitions. Instead of scheduling to prefilling eagerly, this approach waits until all sequences in a batch have finished decoding before initiating the next round of prefilling. However, this scheduling policy results in suboptimal decoding throughput (Agrawal et al., 2024).

### 2. Description Of “Seesaw”

Deep-learning (DL) workloads, including large language model (LLM) inference, often exhibit time-varying compute characteristics, in which the computational, memory, and communication demands of the workload can change over the course of execution. For example, different processing stages of LLM inference workflow may have differing demands on processing resources, memory bandwidth, and inter-device communication during different processing stages. To improve the efficiency of distributed DL workloads having such time varying compute characteristics, such as LLM inference, various parallelization strategies, such as tensor and pipeline parallelism, have been proposed. However, the distinct computational characteristics inherent in multiple processing stages of these workloads, such as the prefilling and decoding stages of the LLM inference, render a single static parallelization strategy insufficient for the effective optimization of all stages of execution.

In an embodiment, the present disclosure provides an example deep-learning (DL) workload execution engine (referred to herein as “Seesaw”) is provided. In one example implementation the DL workload execution engine is embodied as a Large Language Model (LLM) inference engine. The example LLM inference engine (“Seesaw”) is optimized for throughput-oriented tasks. In an embodiment, Seesaw provides dynamic model resharding, a technique that facilitates the dynamic reconfiguration of parallelization strategies across stages, thereby maximizing throughput at both phases. To mitigate re-sharding overhead and optimize computational efficiency, Seesaw employs tiered Key-Value (KV) cache buffering and transition-minimizing scheduling. These approaches work synergistically to reduce the overhead caused by frequent stage transitions while ensuring maximum batching efficiency. An evaluation demonstrates that Seesaw can achieve a throughput increase of up to 1.78× (1.36× on average) compared to vLLM, the most widely used state-of-the-art LLM inference engine.

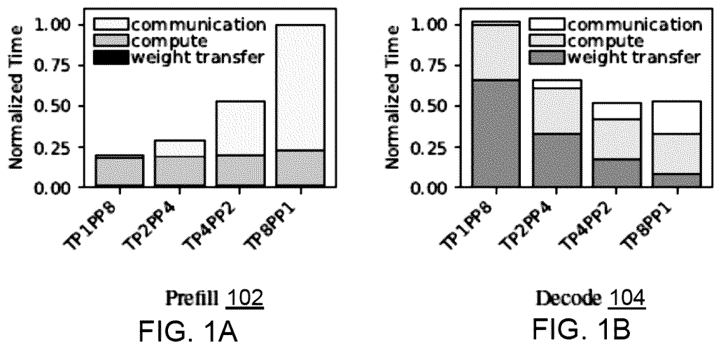

To illustrate the performance limitations of applying a uniform parallelization strategy for both prefill and decode stages, for example, one may measure the execution time of each stage under various combinations of parallelization strategies, i.e., the tensor and pipeline parallelism, as shown in FIGS. 1A and 1B. In the prefill stage 102, as the degree of tensor parallelism increases, the communication overhead increases significantly due to additional GPUs participating in all-reduce operations. As a result, tensor parallelism has been found to perform significantly worse than pipeline parallelism. In contrast, during the decode stage 104, pipeline parallelism can be slower than tensor parallelism, largely due to increased weight transferring overhead caused by micro-batching required for pipelining (see Section 2.2.1 below for more details). Therefore, there is a need for stage-specific parallelization strategies to provide better LLM inference throughput.

An existing approach is disaggregated prefill-decode (Zhong et al., 2024; Qin et al., 2024), which assigns prefill and decode computation to different GPU instances. The prefill instances and decode instances form a two-stage pipeline to serve inference requests. Therefore, the overall throughput of disaggregated prefill-decode is constrained by the slower of the two stages, and balancing throughput between these two stages can be important. The key drawback of disaggregated prefill-decode is that it can cause large amounts of pipeline bubbles under resource-constrained environments. For example, when deploying a 70B model on 8×40 GB GPUs, even the most balanced configuration results in a 6× difference in throughput between the prefill and decode stages. In this setup, the decode stage operates at one-sixth the throughput of the prefill stage, resulting in a significant bottleneck at the prefill stage that slows down the entire system (see Section 2.2.2 below for details).

To address these challenges, the following describes a high throughput deep-learning (DL) workload execution engine, implemented as, for example, an LLM inference engine, (hereinafter also referred to as “Seesaw”) that dynamically switches parallelization strategies between the multiple processing stages of the workload, such as the prefill and decode stages, by reconfiguring partitioning of the workload across computing resources. In one embodiment, the reconfiguring is performed by dynamic model re-sharding. In some other examples, other reconfiguring methods can also be utilized to achieve similar functionality and results as described herein. In an example, Seesaw utilizes model resharding, a novel technique that dynamically re-partitions model weights and KV cache (i.e., where tensors are cached for each sequence's decoding steps) between prefill and decode stages. By tailoring parallelization strategies to the distinct computational demands of each processing stage, Seesaw reduces communication overhead during the prefill stage, while enhancing memory efficiency in the decode stage, resulting in a substantial increase in overall throughput.

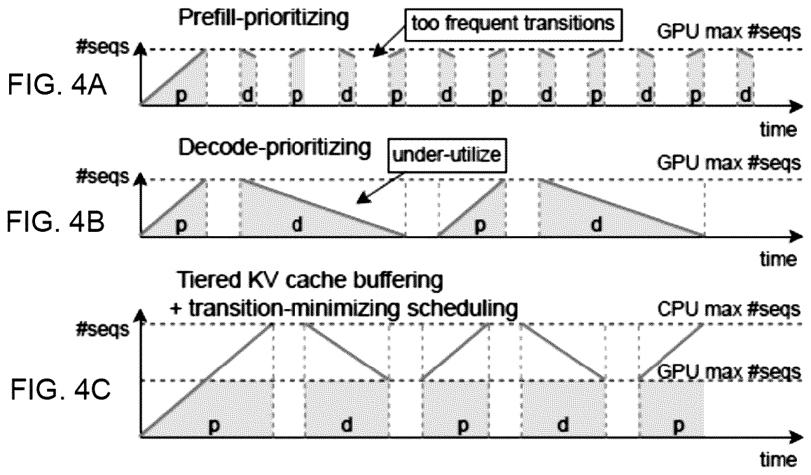

However, the overhead associated with model resharding can be high due to frequent transitions between the prefill and decode stages. To maximize throughput, existing systems typically adopt prefill-prioritized scheduling (Yu et al., 2022; Kwon et al., 2023), which interleaves prefill and decode stages across batches to achieve continuous batching. Yet, as illustrated in FIG. 4A, integrating this approach with model re-sharding can result in significant overhead due to frequent transitions between prefill and decode. On the other hand, decode-prioritized scheduling (NVIDIA, 2024a) completes all decode steps for a batch before proceeding to the next, resulting in lower re-sharding overhead. However, as depicted in FIG. 4B, this method suffers from low resource utilization due to smaller batch sizes.

To overcome this constraint and achieve both minimal re-sharding overhead and large batch size, the following proposes two synergetic techniques: tiered KV cache buffering and transition-minimizing scheduling. Tiered KV cache buffering leverages CPU memory as auxiliary storage for the KV cache, enabling Seesaw to store the KV cache for a large number of prefill requests. Transition-minimizing scheduling reduces re-sharding overhead by minimizing the number of transitions to the decode stage. Seesaw transitions from prefill to decode only after the CPU KV cache is full. During decoding, the large number of KV cache in the CPU buffer enables Seesaw to perform decode with large batch sizes, and thus enabling high throughput. As depicted in FIG. 4C, this approach maintains the maximal batch size during the decode stage, while significantly reducing the frequency of stage transitions, thereby minimizing re sharding overhead. Additionally, to mitigate the overhead of KV cache transfers between CPU and GPU, Seesaw employs asynchronous pipelining to overlap data transfers with computation.

In summary, the following has been recognized and implemented.
Identify and quantitatively analyze the different preferences for parallelization strategies in the prefill and decode stages of throughput-oriented LLM inference tasks. An analysis has been conducted that comprehensively accounts for data movement, computation, and communication costs.
Dynamic model re-sharding, a novel technique that dynamically reconfigures the parallelization strategies for the different processing stages, i.e., the prefill and decode stages in this example. The system addresses the challenge of transition overhead in model re-sharding with continuous batching by introducing tiered KV cache buffering and transition-minimizing scheduling. Based on these techniques, Seesaw provides a high-throughput workload execution system, such as the high throughput offline inference system that optimizes parallelization strategies for each LLM inference stage.
A comprehensive evaluation of Seesaw across a variety of workloads and hardware configurations. Results have shown that Seesaw can achieve an average speed-up of 1.36× and a throughput improvement of up to 1.78× compared to the state-of-the-art LLM inference engines.

### 2.1. Computing Environment

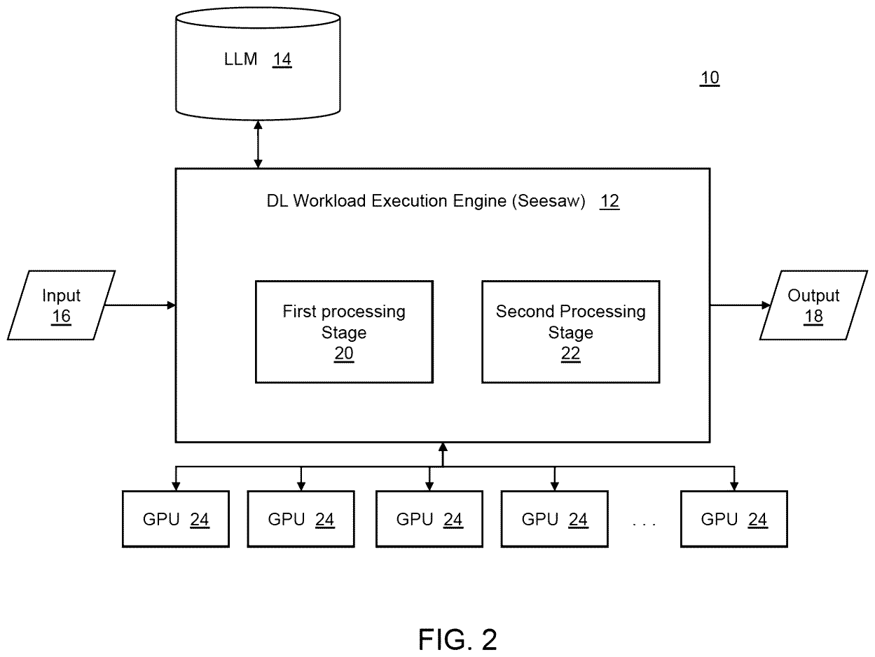

Referring now to FIG. 2, an example of a computing environment 10 is shown in which the present methods, processes and optimizations may be deployed. It can be appreciated that the computing environment 10 is just one example and the methods described herein may be applied to any and all distributed deep-learning tasks, e.g., with time-varying workloads or tasks that can be split into stages, e.g., large vision models. The computing environment 10 includes deep-learning (DL) workload execution engine 12 (i.e., Seesaw). In an example, the DL workload execution engine 12 is implemented as an LLM inference engine, hereinafter referred to as the inference engine 12. The inference engine 12 can be configured to communicate with an LLM 14 to perform inference using one or more graphics processing units (GPUs) 24. The inference engine 12 receives an input 16 that is used along with the LLM 14 to perform an inference that provides an output 18 to an application or entity. The inference engine 12 includes or otherwise implements a number of processing stages, such as a first processing stage 20 and a second processing stage 22 as part of the DL workload. In the illustrated example, the first processing stage 20 is the prefilling stage (hereinafter referred to as the prefilling stage 20) and the second processing stage 22 is the decoding stage (hereinafter referred to as the decoding stage 22).

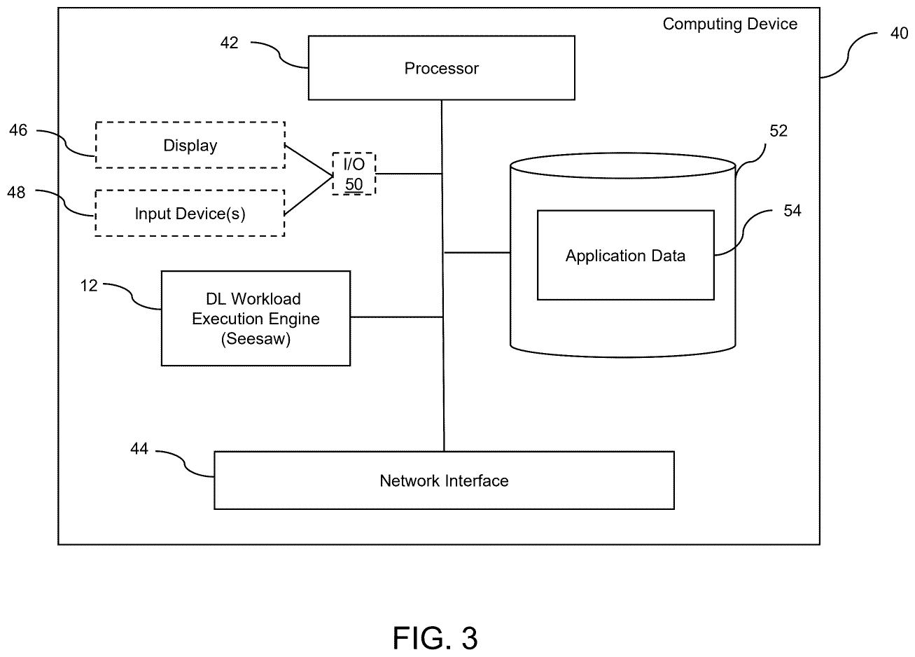

It can be appreciated that the inference engine 12, LLM 14, and/or GPU(s) 24 may be running on one or more computing devices 40 (e.g., see FIG. 3). Such computing devices 40 (or computing systems) may include, but are not limited to, a personal (e.g., desktop) computer, a server computer or other computing system that is equally or more powerful or otherwise suitably adapted to model development, compiling computer code, e.g., for use with machine learning (e.g., DL) and other artificial intelligence applications. Such computing devices 40 may also, where applicable, include a mobile phone, a laptop computer, a tablet computer, a notebook computer, a hand-held computer, a personal digital assistant, a portable navigation device, a wearable device, a gaming device, an embedded device, edge device, a virtual reality device, an augmented reality device, etc.

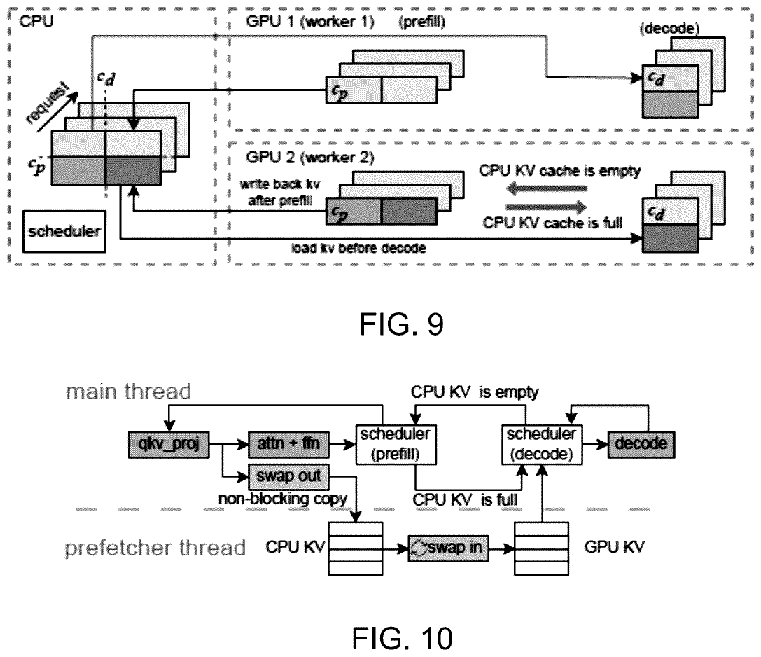

The inference engine 12, LLM 14 and/or the GPU(s) 24 may be hosted or otherwise run on the one or more computing devices 40 or may be accessed by the computing device(s) 40 over a communication network (not shown). Such communication network(s) may include the Internet, accessed via, for example, a telephone network, cellular, and/or data communication network to connect different types of client- and/or server-type devices. For example, the communication network may include a private or public switched telephone network (PSTN), mobile network (e.g., code division multiple access (CDMA) network, global system for mobile communications (GSM) network, and/or any 3G, 4G, or 5G wireless carrier network, etc.), WiFi or other similar wireless network, and a private and/or public wide area network (e.g., the Internet). The network(s) may also include other types of connections such as those coupled to a data center and high-bandwidth connections such as Infiniband, AWS EFA, nvlink, PCIe, etc. The inference engine 12 may implement a scheduling process using a scheduler (see also FIG. 9), which may be embodied in an application, which may take the form of a mobile-type application (also referred to as an “app”), a desktop-type application, an embedded application in customized computing systems, an application programming interface (API), or an instance or page contained and provided within a web/Internet browser, to name a few.

The LLM 14 may be provided by a separate one or more computing devices 40 or computing system, by a separate entity or may be integrated with a system or application running applications for and/or by the inference engine 12 and/or GPU(s) 24 within the same computing device(s) 40 or computing system. As such, the configuration shown in FIG. 2 is illustrative and other computing device/system configurations are possible. For example, the computing environment 10 shown in FIG. 2 may represent a single device or the integration/cooperation of multiple electronic devices such as a client device and server device or a client device and a remote or offsite storage or processing entity or service or multiple client or server devices working together in a compiling or other programming jobs using more than one computing device. That is, the computing environment 10 may be implemented using any one or more electronic devices including standalone devices and those connected to offsite storage and processing operations (e.g., via cloud-based computing storage and processing facilities).

FIG. 3 shows an example of one such computing device 40, e.g., from a set of one or more computing devices 40, which may be utilized by any one or more of the entities shown in FIG. 2, for example, a server or platform used to provide the inference engine 12 and/or LLM 14 and/or GPU(s) 24, or other computing device 40 used to communicate with a device generating and/or providing the output 18. The computing device 40 in FIG. 3 may, additionally or alternatively, provide an example of a device on which the output 18 is used. Similarly, the computing device 40 in FIG. 3 may provide an example of a device on which downstream application(s)—not shown, may be deployed.

In this example, the computing device 40 includes one or more processors 42 (e.g., a microprocessor, microcontroller, embedded processor, digital signal processor (DSP), central processing unit (CPU), media processor, graphics processing unit (GPU), accelerators such as TPUs and NPUs, or other hardware-based processing units) and one or more network interfaces 44 (e.g., a wired or wireless transceiver device connectable to a network via a communication connection).

Examples of such communication connections can include wired connections such as twisted pair, coaxial, Ethernet, fiber optic, etc. and/or wireless connections such as LAN, WAN, PAN, cellular, and/or via short-range communications protocols such as Bluetooth, WiFi, NFC, IR, etc. As noted above, communication connections described herein may also include other types of connections such as those coupled to a data center and high-bandwidth connections such as Infiniband, AWS EFA, nvlink, PCIe, etc.

The computing device(s) 40 may also include the inference engine 12 (or other application(s), a data store 52, and client application data 54. The data store 52 may represent a database or library or other computer-readable medium configured to store data and permit retrieval of data by the computing device 40. The data store 52 may be read-only or may permit modifications to the data. The data store 52 may also store both read-only and write accessible data in the same memory allocation. In this example, the data store 52 stores the application data 54 for the inference engine 12 (e.g., for scheduling using a scheduler) that is configured to be executed by the computing device 40 for a particular role or purpose.

While not delineated in FIG. 3, the computing device(s) 40 include(s) at least one memory or memory device that can include a tangible and non-transitory computer-readable medium and/or volatile memory such as RAM, having stored therein computer programs, sets of instructions, code, or data to be executed by processor(s) 42. The processor(s) 42 and network interface(s) 44 are connected to each other via a data bus or other communication backbone to enable components of the computing device 40 to operate together as described herein. FIG. 3 illustrates examples of modules and applications stored in memory on the computing device 40 and executed by the processor(s) 42.

It can be appreciated that any of the modules and applications shown in FIG. 3 may be hosted externally and may be available to the computing device 40, e.g., via the network interface 44. The data store 52 in this example stores, among other things, the application data 54 that can be accessed and utilized by the obfuscation system (and/or the model developer). The data store 52 may additionally store one or more software functions or routines in a cache or in other types of memory.

As shown in FIG. 3, the computing device(s) 40 may, optionally (e.g., when configured as a personal electronic device such as a smartphone or tablet), include a display 46 and one or more input device(s) 48 that may be utilized via an input/output (I/O) module 50. That is, such components may be omitted when the computing device 40 does not interact with a user.

While examples referred to herein may refer to a single display 46 for ease of illustration, the principles discussed herein may also be applied to multiple displays 46, e.g., to view portions of Uls rendered by or with an application on separate side-by-side screens. That is, any reference to a display 46 may include any one or more displays 46 or screens providing similar visual functions. The application receives one or more inputs from one or more input devices 48, which may include or incorporate inputs made via the display 46 as well as any other available input to the computing environment 10 (e.g., via the I/O module 50), such as haptic or touch gestures, voice commands, eye tracking, biometrics, keyboard or button presses, etc. Such inputs may be applied by a user interacting with the computing environment 10, e.g., by operating the computing device 40.

### 2.2 Motivation And Analysis

In this section, an in-depth analysis of two key observations identified from FIG. 1 is provided: (1) Tensor parallelism often exhibits significantly worse performance than pipeline parallelism during the prefill stage due to its substantial communication overhead; and (2) Pipeline parallelism tends to fall short in the decode stage owing to the considerable weight loading overhead it incurs. It may then be proposed that a dynamic parallelization strategy is important to attain optimal performance across both stages.

Given the importance of batching in throughput-oriented tasks, it can be useful to consider how different parallelization strategies impact the maximum batch size, rather than assuming batch size as a tunable parameter, as is often done in online-serving contexts such as DistServe (Zhong et al., 2024) and Sarathi-serve (Agrawal et al., 2024).

### 2.2.1 Parallelism Analysis

Observation 1: Tensor parallelism (TP) incurs substantial communication overhead during the prefill stage. In Tensor parallelism, each device performs a part of computation and aggregate the partial result. The activations at each layer are synchronized across all GPUs using all-reduce operations. The overhead associated with this operation can be quantified as:

$$\frac{\# tokens \times activation size}{all - reduce bandwidth} ,$$

where all-reduce bandwidth refers to the rate of data transfer during all-reduce operations, calculated as the size of the tensor being all-reduced divided by the all-reduce runtime.

As the degree of tensor parallelism increases, the proportion of execution time of all-reduce operations grows substantially. This growth can be attributed to two main factors. First, while model weights are partitioned, activations in tensor parallelism remain fully replicated across GPUs 24, leading to a constant activation size regardless of the degree of tensor parallelism. Second, all-reduce bandwidth decreases as the number of GPUs 24 grows, due to more complex communication schemes. Therefore, increasing the degree of tensor parallelism may not only fail to reduce the traffic of all-reduce operations but may further limit the communication bandwidth, resulting in escalated communication overhead. This issue is particularly pronounced in the prefill stage, where a large number of tokens are processed simultaneously, making communication overhead the primary bottleneck. Thus, tensor parallelism tends to perform worse than pipeline parallelism during the prefill stage due to its large communication overhead.

Observation 2: Pipeline parallelism (PP) suffers from significant weight transferring overhead in the decode stage. Pipeline parallelism distributes model layers sequentially across devices, with each device responsible for processing a set of consecutive layers before passing the output to the next device. Due to the auto-regressive nature of LLM inference, a sequence cannot enter the pipeline until its preceding token is generated. As a result, at any given time step, a sequence can appear in only one stage of the pipeline, making the batches processed by each device mutually exclusive. However, the total number of sequences that the pipeline can handle at a time, referred to as the global batch size, is constrained by the size of KV cache. Given the mutual exclusion of batches at each device, pipeline parallelism can process only approximately 1/PP of the global batch per forward pass. This reduced batch size in pipeline parallelism may be referred to as the micro-batch size.

Dividing batches into micro-batches increases the number of LLM forward passes required to process the same amount of requests. Specifically, a pipeline parallelism degree of PP necessitates PP times more forward passes for a given global batch. This repeated execution degrades inference performance, as model weight matrices need to be loaded from global memory repeatedly. This inefficiency is especially significant in the decode stage, where weight-loading overhead accounts for a substantial portion of total execution time. As a result, pipeline parallelism generally underperforms relative to tensor parallelism in the decode stage due to the amplified weight loading overhead.

Discussion on Data Parallelism: Unlike tensor and pipeline parallelism, which distribute the model across devices, data parallelism (DP) distributes the data while duplicating the model. While data parallelism has minimal communication overhead, it has two observed disadvantages: (1) the volume of weight transferring is higher by the number of duplicates compared to tensor parallelism; and (2) it occupies more GPU memory, reducing the available space for the KV cache and thus limiting the maximum batch size resulting in lower throughput. Data parallelism can be applied orthogonally alongside both tensor and pipeline parallelism. We do not dynamically adjust data parallelism, which will be explained in Section 2.3.1 below.

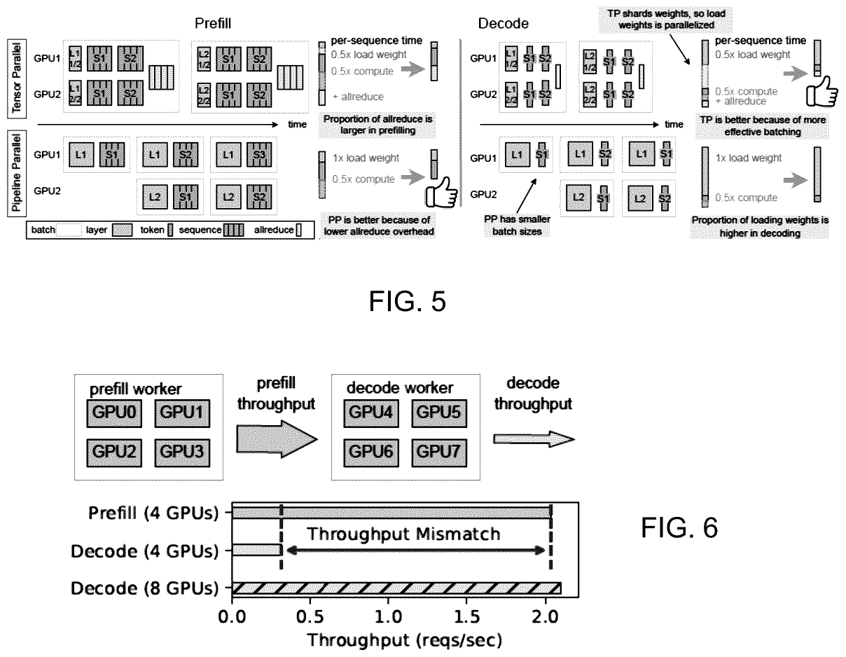

Conclusion: No one-size-fits-all. When comparing these three parallelism strategies for high-throughput LLM inference, a key observation is that prefilling and decoding stages benefit from different parallelism approaches. This difference arises from the distinct characteristics of each stage, as illustrated in FIG. 5. For example, tensor parallelism is preferred for the decoding stage due to its ability to efficiently accelerate weight matrix loading. However, it incurs significant communication overhead, as it requires all-reduce operations at each layer. In contrast, pipeline and data parallelism have much lower communication overhead, making them preferable for the prefilling stage. However, their decoding throughput is limited by inefficient batching and additional weight-loading overhead.

To quantitatively analyze the trade-offs across different parallelisms, the average runtime per sequence (the inverse of throughput) may be modeled as follows. Derivations and further details are provided in the section 2.8 below.

$$T ∝ \frac{{T}_{dm}^{linear}}{TP} + \frac{{T}_{dm}^{attn} + {T}_{comp}}{DP \cdot TP \cdot PP} + \frac{{T}_{comm} ( TP )}{PP \cdot DP}$$

$$Here {T}_{dm}^{linear}$$

represents data movement for linear layers (primarily model weights),

$${T}_{dm}^{attn}$$

represents data movement for attention layers (primarily KV cache), T_{comp} represents computation time, and T_{comm} represents communication time.

Note that T_{comm} is a monotonically increasing function with respect to TP, as all-reduce operations require more time as TP increases.

Tensor parallelism can effectively accelerate loading model weights, which is

$${T}_{dm}^{linear} ,$$

parallelism effectively reduce the overhead of communication, while tensor parallelism contrarily increases the communication overhead. In prefilling,

$${T}_{dm}^{linear}$$

is negligible, and T_{comm} becomes larger, so pipeline and data parallelisms are more preferred, while in decoding,

$${T}_{dm}^{linear}$$

occupies a larger proportion so tensor parallelism is more advantageous.

### 2.2.2 why not Disaggregate Prefilling and Decoding?

Spatially disaggregating prefilling and decoding with separate hardware resources, as done in online serving systems such as DistServe (Zhong et al., 2024) and MoonCake (Qin et al., 2024), is one approach to separately select parallelization strategies for prefilling and decoding. Sequences are first processed by the devices dedicated for prefilling before being transferred to decoding devices.

However, there are two obstacles when applying prefill-decode disaggregation to purely throughput-oriented scenarios. First, since the overall throughput is bound by the slower stage, the throughput of prefilling and decoding needs to be matched by adjusting the devices allocated for each stage. However, it can be impractical in resource-constrained scenarios. For example, as shown in FIG. 6, to deploy a 70B model (which takes 140 GiB memory for model weights) on eight 40 GiB GPUs, there is only one disaggregation strategy, that is four GPUs for prefilling and four for decoding (at least four GPUs (160 GiB memory) are needed to fit the model weights. However, it causes severe throughput mismatch where prefilling has more than 6× higher throughput than decoding. Second, disaggregation duplicates the model weights similarly to data parallelism, bringing similar drawbacks, such as limited KV cache space and increased weight transfer. As a result, decoding throughput with four GPUs is only 15% of that with eight GPUs 24 in these observations.

In conclusion, although disaggregation allows for selecting different parallelization strategies for each stage, the throughput mismatch between stages and limited resources allocated to each can lead to suboptimal performance. This calls for a method that offers flexibility in parallelization while maximizing hardware resource utilization.

### 2.3. SEESAW-DL Workload Execution Engine 12

### 2.3.1 Dynamic Model Re-Sharding

Observing that the various processing stages, i.e., the prefilling and decoding stages in the illustrated example, have distinct preferences for parallelism, in an embodiment, the engine 12 is configured to use a technique called dynamic model re-sharding to dynamically reconfigure a partitioning of the DL workload across computing resources. This technique enables the selection of different parallelization strategies for each processing stage and automatically transitions between them. This approach expands the configuration space, allowing for separate optimization of the separate processing stages, potentially improving overall throughput compared to using a single configuration. In the following description, the parallelization strategy used in prefilling is denoted as cp and that in decoding is denoted as Cd.

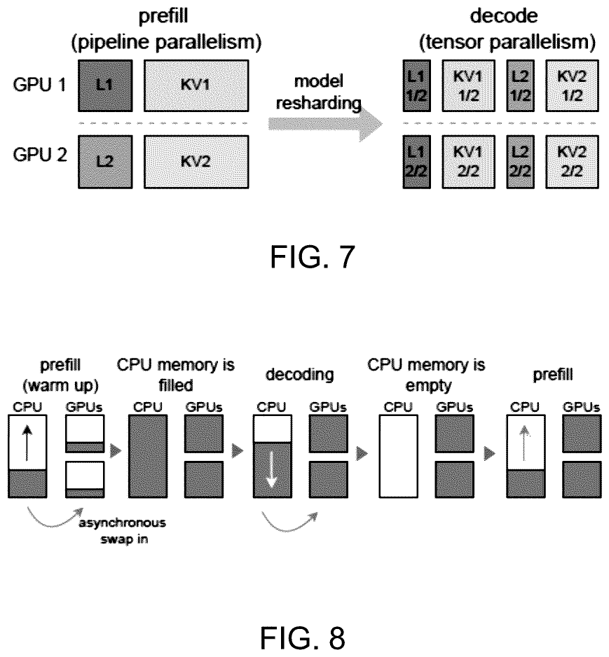

To support transitions between different parallelization configurations, the cluster rearranges the data stored on each device to align with the new parallelism which involves both model weights and KV cache, as illustrated in FIG. 7. In Seesaw, model parameters, such as model weights are re-sharded by reloading the required shards from CPU memory, and KV cache re-sharding is performed through CPU shared memory.

The inter-device movement of tensors incurs overhead. To mitigate this re-sharding cost, in an embodiment, the engine 12 is configured to use an asynchronous pipeline to overlap data transfer with computation, as detailed in Section 2.4.2.

Discussion on data parallelism: Unlike switching between tensor and pipeline parallelism, adjusting the degree of data parallelism alters the proportion of GPU memory allocated to model weights versus KV cache. This adjustment increases system complexity or necessitates additional data movement between the CPU and GPU 24. Therefore, the engine 12 only dynamically adjusts tensor and pipeline parallelism.

### 2.3.2 Tiered KV Cache Buffering and Transition-minimizing Scheduling

Challenge: Transition Overhead. In practice, dynamic model resharding encounters an obstacle of transition overhead, which is amplified by the widely used continuous batching and prefill-prioritizing scheduling. Prefill prioritizing scheduling eagerly schedules new prefilling tasks, causing frequent transitions between the two stages. As a result, directly applying model re-sharding with this interleaved prefill-decode scheduling policy would introduce significant re-sharding overhead. On the other hand, decode prioritizing scheduling minimizes the frequency of transitions but results in suboptimal decoding throughput. Other compromise solutions involve setting a threshold-based approach for managing the prefill-decode transition (Cheng et al., 2024). However, they still involve a trade-off between reducing transition overhead and maximizing decoding throughput.

To address this problem, in an embodiment, the engine 12 is configured to utilize: 1) tiered KV cache buffering, which leverages CPU memory offloading; and 2) transition-minimizing scheduling policy. These two synergistic techniques prevent frequent stage transitions and maintain a high decoding throughput.

In an example implementation, tiered KV cache buffering uses CPU memory as auxiliary storage for the KV cache, enabling the pre-computation of a large batch of prefilling consecutively. During the prefill stage, the generated KV cache is offloaded to CPU KV cache storage, freeing it from the limitations of GPU memory space. During decoding, continuous batching runs as normal, except that new sequences are on-boarded by swapping in its KV cache from the CPU memory.

Transition-minimizing scheduling policies are configured to control the transition or switching between the processing stages to only happen when the CPU KV cache storage is either full or empty. For example, during the prefill stage, once the CPU KV cache storage is fully utilized, re-sharding is triggered, and the cluster transitions to decoding. During decoding, GPUs 24 continue processing requests and loading KV cache from CPU memory, keeping GPU KV cache fully utilized for high decoding throughput. When the entire CPU KV cache has been transferred (or emptied) to GPU memory, the cluster switches back to prefilling. The whole process is illustrated in FIG. 8.

KV cache re-sharding occurs throughout this process. As illustrated in FIG. 9, in a multi-GPU setup, the CPU KV cache storage is shared among all GPUs 24. During swap-out, each GPU 24 pushes its shard (based on Cp) of the generated KV cache to the shared CPU storage, where these shards collectively form the complete KV cache. During swap-in, each GPU 24 retrieves its required KV shard (based on Cd) from the shared storage. The engine 12 may implement the shared KV cache using shared memory of the operating system.

### 2.4. Engine Design and Implementation

### 2.4.1 Scheduler-Worker Architecture

In order to support dynamically switching parallelization configurations for prefilling and decoding stages, in an embodiment, Seesaw provides the new LLM inference engine 12 designed for high-throughput LLM inference tasks. In an example implementation, the overall architecture of Seesaw follows a single-scheduler, multi-worker design. The scheduler manages all generation requests, organizes them into batches, and sends instructions to the workers. To fully utilize pipelining, each decoding step processes 1/PP of the sequences in GPU KV storage. Once a batch is formed, it is sent to workers through shared queues. Each worker is responsible for controlling a single GPU 24 and maintains a task queue to receive and execute instructions sequentially. This architecture facilitates the implementation of asynchronous features, such as pipeline parallelism and the asynchronous pipeline for tiered KV cache buffering.

### 2.4.2 Asynchronous Pipeline

While re-sharding and tiered KV cache buffering offer substantial benefits, they also introduce new overhead related to moving model weights and KV cache. The overhead of reloading model weights remains constant relative to batch size, allowing it to be amortized with larger batches. In contrast, swapping the KV cache incurs overhead proportional to batch size, making it harder to amortize. Fortunately, these overheads can be mitigated through computation-communication overlap. To that end, in an embodiment, the engine 12 is configured to implement an asynchronous pipeline to overlap KV cache transfer with ongoing computation, as illustrated in FIG. 10.

Overlap swap-out with computation: The KV cache generated during the prefilling stage is not used until decoding begins, allowing the KV cache swap-out to overlap with other computations during prefilling. Although CPU-GPU data transfer is relatively slow due to PCIe bandwidth limitations, it can still be overlapped with computation, given the high FLOPS involved in prefilling.

In practice, CPU-GPU data transfer can only overlap with computation when using pinned memory, but shared memory cannot be pinned (AlbanD, 2023). To address this, the engine 12 is configured to split the transfer into two stages: GPU to pinned memory (overlapped with computation) and then pinned to shared memory, which is a host-side operation that also runs concurrently with GPU kernels.

Asynchronous swap-in: The engine can implement swap-in using a background thread called the prefetcher on each worker, operating in a fully asynchronous paradigm. The prefetcher is controlled directly by the scheduler and runs independently of the main thread, whether the main thread is handling prefilling or decoding. In each iteration, the scheduler creates new prefetching tasks when there are free slots in the GPU KV store. Once the prefetcher completes moving the KV cache for certain sequences, it notifies the scheduler via a shared queue, allowing those sequences to be scheduled for decoding tasks later. As long as the output length is not too short, the swap-in can also be well overlapped.

Bandwidth-aware KV cache layout: The data layout of the KV cache significantly impacts the bandwidth efficiency of data movement. There are two common layouts for storing KV cache: (seq len, num heads, head dim) (NHD) and (num heads, seq len, head dim) (HND). NHD is less optimal for memory access because tensor parallelism shards the KV cache along the H dimension (number of heads), which is the second-to-last dimension, leading to more noncontiguous memory access. Therefore, the engine 12 may use the HND layout for storing the KV cache in CPU memory.

### 2.5. Evaluation

In this section, the performance of Seesaw under a variety of hardware configurations and workloads is explored.

### 2.5.1 Experiment Settings

Hardware. Use three types of GPUs 24: NVIDIA A10, L4, and A100. The A10 and L4 are deployed on AWS EC2 instances (g5.48×large and g6.48×large (Amazon Web Services, 2024)), and the A100 is used on GCP (Google Cloud, 2024). GPU specifications are listed in Table 1.

TABLE 1
GPU hardware specification

| GPU | Memory | Memory | | |
|---|---|---|---|---|
| Model | Size | Bandwidth | FLOPS | NVLink |
| A10 | 24 GiB | 600 GiB/S | 125 T | X |
| L4 | 24 GiB | 300 GiB/s | 121 T | X |
| A100 | 40 GiB | 1,555 GiB/S | 312 T | ✓ |

The PCIe connection for each GPU is PCIe 4.0 8×, providing 16 GiB/s bandwidth (PCI-SIG, 2017), while NVLink (NVIDIA Corporation, 2024) offers a bandwidth of 600 GiB/s. Additionally, 80 GiB of CPU memory is allocated per GPU.

Model: Use three different LLMs with different sizes: (1) a 15B variety of LLaMA3 (Elinas, 2024); (2) CodeLLaMA-34B (Roziere et al., 2023); (3) LLAMA2-70B (Touvron et al., 2023b). They all use Grouped Query Attention (GQA) (Ainslie et al., 2023). For brevity, refer to them as 15B, 34B, and 70B, respectively, in the following sections. Use float16 as the data type.

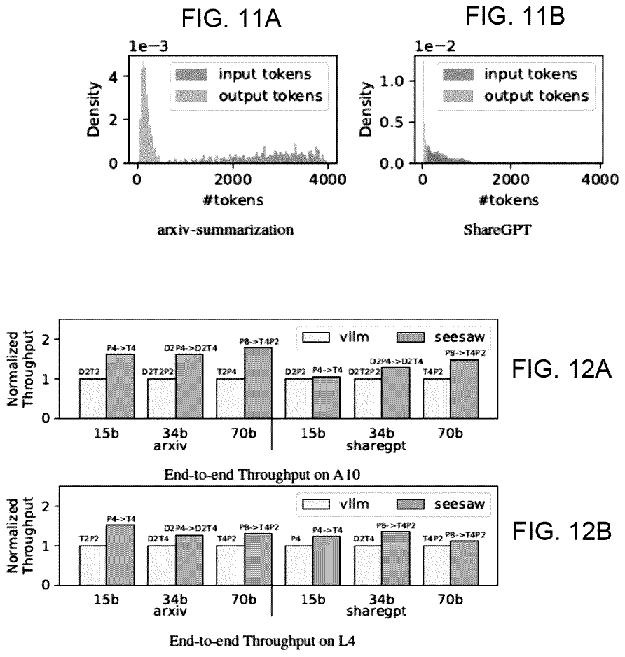

Workload: Use two different datasets in the evaluation, namely sharegpt (ShareGPT, 2023) and arxiv-summarization (Cohan et al., 2018). They correspond to two different distributions of workload. Sharegpt is a dataset of chatting history, so its input and output have comparable lengths, while arxiv-summarization dataset is a summarization dataset where inputs are much longer than outputs. The characteristics of these two datasets are shown in FIGS. 11A and 11B. Sample 2000 requests from the Sharegpt dataset and 500 requests from arxiv-summarization and also use constant-length workloads in Section 2.5.5. Since Seesaw is throughput-oriented, the end-to-end throughput are measured as the metrics.

Baselines: Use vLLM 0.5.4 (Kwon et al., 2023) as the baseline. It is the most widely used open-source LLM serving engine with wide support for different parallelisms. Also directly use the vLLM's model implementation for a straightforward comparison. SGLang (Zheng et al., 2023) and DeepSpeed-FastGen (Holmes et al., 2024) do not support pipeline parallelism. TensorRT-LLM (NVIDIA, 2024b) is not included in the comparison because it uses a similar scheduling policy as vLLM, and vLLM demonstrates comparable performance (vLLM Team, 2024) in throughput-oriented tasks. The techniques proposed in Seesaw can also be applied to modifying TensorRT-LLM.

Enable chunked prefill and tune the chunk size for vLLM to get the optimal throughput, following the practice of Sarathi-serve (Agrawal et al., 2024). Otherwise, suboptimal chunk sizes would cause severe throughput degradation.

### 2.5.2 End-to-End Throughput on PCIe Systems

First, measure the end-to-end throughput of Seesaw. Sweep over all available single parallelism configurations for vLLM and show the result of the best configuration. Use four GPUs 24 for the 15B model, and eight GPUs for the 34B and 70B models. The result is shown in FIGS. 12A and 12B, with the used parallelism labeled above each bar. On A10, compared with the highest single parallelism baseline, Seesaw achieves a geometrically average speedup of 1.45×, with up to 1.78× speedup. On L4, Seesaw achieves a geometrically average speedup of 1.29×, with up to 1.52× speedup. The overall average speedup is 1.36×. The speedup is more significant on A10, because A10 has better single GPU 24 performance than L4, while they have similar PCIe inter-connection bandwidth, causing a higher percentage of communication overhead.

### 2.5.3 Speedup Breakdown: An Example

FIG. 14 illustrates how Seesaw merges the advantages of different parallelisms. Using CodeLLaMA34B on the arxiv-summarization dataset with four A10 GPUs as an example, measure the runtime of each stage. TP4 is optimal for decoding but significantly slower for prefilling, while PP4 excels at prefilling but is slower during decoding. Seesaw uses a mixed parallelism strategy, applying PP4 for prefilling and TP4 for decoding, achieving performance comparable to the best configuration for each stage.

Compared to the optimal single parallelism configuration (TP2PP2) with chunked prefill, Seesaw is still faster because (1) chunked prefill does not piggy-back all decoding steps, leaving some purely decoding steps, and (2) chunked prefill with TP2PP2 is slower than prefilling with PP4.

### 2.5.4 End-to-End Throughput on A100

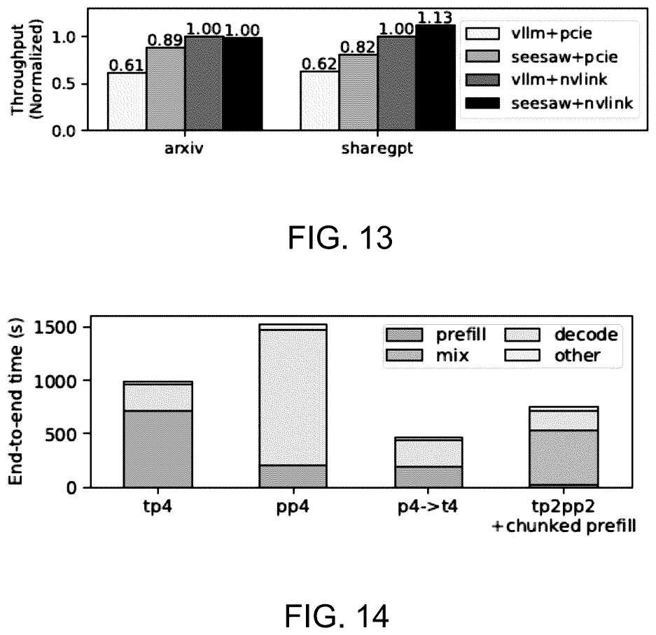

Speedup on A100+NVLink The NVLink interconnection across A100 GPUs can significantly reduce the all-reduce overhead and further scales tensor parallelism. Usually, tensor parallelism alone is enough to achieve optimal performance when there are no more than four GPUs. Nevertheless, there is still a noticeable percentage of all-reduce overhead in prefilling when tensor parallelism scales beyond four GPUs 24. Seesaw can still provide speedup in this case. As shown in FIG. 13, Seesaw can still achieve a 13% throughput increase over vLLM for the sharegpt dataset on LLaMA3-70B on eight A100s.

Speedup on A100+PCIe. Besides A100 SXM with NVLink inter-connection, there is also another version of A100 that is inter-connected with PCIe links, where Seesaw can achieve noticeable speedup. As shown in FIG. 13, Seesaw can provide 46% speedup on arxiv-summarization and 30% speedup on sharegpt. Seesaw brings the performance of the A100 PCIe version much closer to the performance level of the NVLink version. vLLM gets roughly 60% throughput on A100 PCIe compared with A100 SXM, while Seesaw boosts it up to 82%-89%.

### 2.5.5 Sensitivity Study

Ratio between Input and Output Length: The speedup of Seesaw depends on the ratio between the input and output length, or P: D. Model re-sharding has the opportunity to provide speedup when prefilling and decoding have balanced time. To investigate to what extent model re-sharding would be effective, the throughput of various parallelization strategies on synthesized datasets with uniform lengths and different P: D ratios can be measured. The input length is fixed as 3000 and the output length is variable.

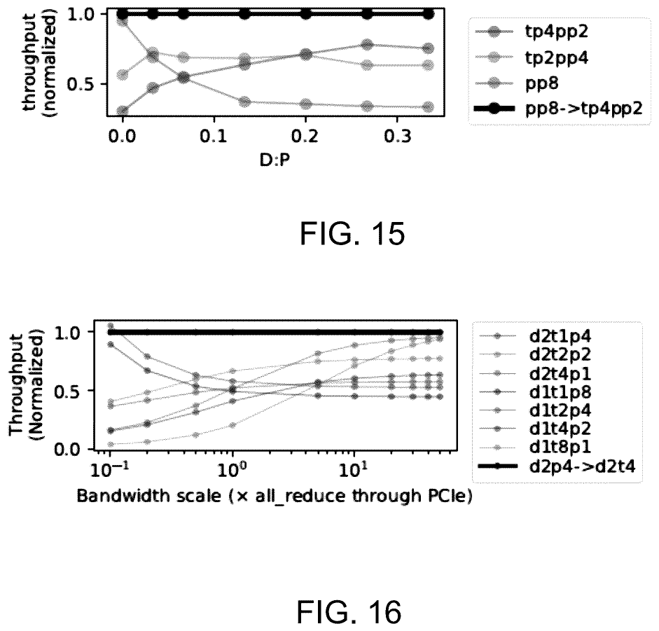

As shown in FIG. 15, PP8 achieves the highest throughput during prefilling, while TP4PP2 excels in decoding. When the output length equals one (prefilling only), Seesaw and PP8 show similar throughput, and TP4PP2 performs worse due to high communication overhead. As output length increases, the inefficiency of PP in decoding outweighs its advantage in prefilling, causing PP8's throughput to drop rapidly. There is a range where TP2PP4 becomes optimal before decoding dominates the runtime and TP4PP2 takes over as the fastest. Nonetheless, Seesaw achieves the highest overall throughput across all data points. In real scenarios with variable input and output lengths, Seesaw is even more advantageous due to its adaptive capabilities.

Inter-connection Bandwidth: The effectiveness of Seesaw also depends on the inter-connection bandwidth. This can be investigated by measuring the runtime and tracing all reduce operations of running arxiv-summarization and 34B model on eight A10s. Then, mutate the all-reduce time to project the end-to-end throughput with different inter-connection bandwidths. As shown in FIG. 16, when the inter-connection bandwidth is slow (for example, among geographically distributed devices (Borzunov et al., 2022)), pipeline parallelism is optimal; when the bandwidth is very high, tensor parallelism is optimal. The throughput of Seesaw is superior to fixed parallelization strategies on a wide range from 0.1× to 50× of PCIe bandwidth.

### 2.6. Related Work

### 2.6.1 Heterogeneity Between Prefilling and Decoding

Due to the different computational characteristics between prefilling and decoding leading to under-utilization of hardware resources, prior research has investigated two directions to address this problem, namely disaggregating or merging the two stages. Disaggregation places prefilling and decoding onto different devices to avoid their interference while merging processes prefilling and decoding in one batch.

Disaggregate Prefill and Decoding: DistServe (Zhong et al., 2024) proposed placing prefilling and decoding on different devices to prevent interference and leverage different characteristics of the two stages. Mooncake (Qin et al., 2024) uses similar through a distributed KV cache pool. P/D-Serve (Jin et al., 2024) uses the device-to-device network to transfer the KV cache between prefill and decode devices. Splitwise (Patel et al., 2024) proposes using different GPU models for the two stages. Tetrilnfer (Hu et al., 2024) further disaggregates different downstream tasks to avoid interference. These works are designed for online serving while Seesaw focuses on offline inference. Moreover, they are usually designed for large clusters.

Merge Prefill and Decode. Chunked prefill, as proposed by SplitFuse (Holmes et al., 2024), Sarathi (Agrawal et al., 2023), and Sarathi-serve (Agrawal et al., 2024), splits long prompts in the prefilling stage into smaller chunks, combining them with decoding steps to strike a balance between data movement and computation and reduce pipeline bubbles in pipeline parallelism. However, determining the optimal chunk size is challenging. A chunk size that's too large results in excessive decode-only steps, closely resembling traditional prefill-decode scheduling. Conversely, a chunk size that's too small reduces kernel efficiency.

### 2.6.2 Parallel and Distributed LLM Inference

Aside from tensor parallelism, pipeline parallelism, and data parallelism discussed in Section 1.2 above, there are also other types of parallelisms, such as sequence parallelism (SP) (Li et al., 2021; Liu et al., 2023; Lin et al., 2024; Brandon et al., 2023; Xue et al., 2024) and fully sharded data parallelism (FSDP) (Zhao et al., 2023; Rajbhandari et al., 2020). Sequence parallelism is especially designed for long sequence lengths, and is orthogonal with our work. FSDP requires frequently transferring weight matrices across GPUs, thus mainly used in training.

HexGen (Jiang et al., 2023), LLM-PQ (Zhao et al., 2024), Helix (Mei et al., 2024) investigate parallelisms in heterogeneous clusters. Intra-device parallelism leverages overlapping functions using different resources within each device, including NanoFlow (Zhu et al., 2024) and Liger (Du et al., 2024). Petals (Borzunov et al., 2022) explores LLM inference in geographically distributed setups, employing pipeline parallelism to minimize communication costs. SpotServe (Miao et al., 2024) runs LLM inference on preemptible instances.

### 2.6.3 Offloading in LLM Inference

Offloading is a widely used technique to run LLM applications in resource-constrained scenarios (Ren et al., 2021). FlexGen (Sheng et al., 2023) swaps tensors across GPU memory, CPU memory, and disks. Fiddler (Kamahori et al., 2024), HeteGen (Xuanlei et al., 2024), PowerInfer (Song et al., 2023) and FastDecoder (He & Zhai, 2024) perform part of computation in CPU, which require CPUs with strong compute capability or external CPU nodes connected with high-bandwidth networking. Instinfer (Pan et al., 2024) offloads computation to Computational Storage Drives.

### 2.7. Conclusion

The present disclosure describes a high-throughput DL workload execution engine 12, Seesaw, implemented as a high-throughput LLM inference engine, in one example, to address the inefficiencies of fixed parallelization by selecting different parallelization strategies for the prefilling and decoding stages and switching between them using model re-sharding. The engine 12 is configured to use tiered KV cache buffering to minimize re-sharding overheads. Experiments have shown that Seesaw can outperform widely used open-source inference engines, with a throughput increase of 1.06-1.78× and an average throughput improvement of 1.36×. These results highlight Seesaw's effectiveness and adaptability.

### 2.8. Performance Model

In this section, the trade-offs of various parallelism strategies are examined by developing an analytical performance model. The following breaks down the model's inference time into multiple components and analyze the impact of each parallelism type on these components. The results reveal that the proportion of these components differs across workloads, resulting in distinct scaling behaviors for each parallelism strategy. Table 1 below lists the notations used in the analysis. Assume the data type is float16.

TABLE 1
Notations

| | | | |
|---|---|---|---|
| DP | data parallel degree | ${T}_{dm}^{linear}$ | time of transferring weights |
| TP | tensor parallel degree | ${T}_{dm}^{attn}$ | time of transferring kvcache |
| PP | pipeline parallel degree | ${T}_{comp}^{linear}$ | time of linear layer computation |
| b | (global) batch size | ${T}_{comp}^{attn}$ | time of attention computation |
| s | average sequence length | T_{n,w} | time of communication |
| | | | (all_reduce) |
| h_{q} | number of heads | L | number of layers |
| hₖᵥ | number of KV heads | W | number of parameters in one layer |
| d | bead dimension | M | memory capacity of a GPU |

### 2.8.1 Runtime Breakdown

The runtime of each decoding layer can be divided into three components: 1) data movement (T_{dm}) from GPU global memory (HBM) to compute units, which includes transferring weights

$$( {T}_{dm}^{linear} )$$

and KV cache

$$( {T}_{dm}^{attn} ) ,$$

2) computation T_{comp} including

$${T}_{comp}^{linear} and {T}_{comp}^{attn} ,$$

and 3) communication cost T_{nw} (nw stands for network), primarily arising from the all-reduce operation in tensor parallelism. Based on the roofline model, the runtime of each layer can be approximated as

$${T}_{L} = max ( {T}_{dm}^{linear} , {T}_{comp}^{linear} ) + max ( {T}_{dm}^{attn} , {T}_{comp}^{attn} ) + {T}_{nw} .$$

Data Movement: The runtime of data movement can be approximated as transferred data volume divided by the bandwidth, which is the HBM bandwidth for GPUs 24. For linear layers, the transferred data is mostly weight matrices, of which the size is 2 W bytes, which is constant. For attention layers, the transferred data is most the Q, K, and V matrices, which is 2bs (h_{q}+2hₖᵥ) d bytes in prefilling and 4bshₖᵥd in decoding.

Compute: The computation time can be approximated as the number of floating operations (FLOPs) divided by the number of floating operations per second of the hardware (FLOP/s). For linear layers, the FLOPs is proportional to the weight parameters times the number of tokens, which is 2 Wbs in prefilling and 2 Wb in decoding. For attention layers, most operations come from computing the attention score, which is approximated as bh_{q}s²d² in prefilling and 2bh_{q}sd₂ in decoding.

TABLE 2
Different components of the runtime of a forward pass.
The batch size b representing the batching effect is emphasized.

| | ${T}_{dm}^{linear}$ | ${T}_{comp}^{linear}$ | ${T}_{d m}^{attn}$ | ${T}_{comp}^{attn}$ | ${T}_{nw} ( TP )$ |
|---|---|---|---|---|---|
| Prefill | $\frac{2 W}{{B}_{HBM}}$ | $\frac{2 {bW}_{s}}{FLOPS}$ | $\frac{2 bs ( {h}_{q} + 2 {h}_{kv} ) d}{{B}_{HBM}}$ | $\frac{{bh}_{q} {s}^{2} {d}^{2}}{FLOPS}$ | $\frac{4 {bsh}_{q} d}{{B}_{ar} ( TP )}$ |
| Decode | $\frac{2 W}{{B}_{HBM}}$ | $\frac{2 bW}{FLOPS}$ | $\frac{4 {bsh}_{kv} d}{{B}_{HBM}}$ | $\frac{2 {bh}_{q} {sd}^{2}}{FLOPS}$ | $\frac{4 {bh}_{q} d}{{B}_{ar} ( TP )}$ |

Communication: The communication cost mostly comes from the all-reduce operation in tensor parallelism. It can be modeled as the transferred data volume divided by the bandwidth. Denote it as T_{nw} (TP), and approximate it as b·A/Bₐᵣ (TP) where A is the size of the activation of one request within a batch and Bₐᵣ (TP) is the all-reduce bandwidth. T_{nw} (TP) is monotonically increasing with TP as additional GPUs 24 and more replicas of activations are added to all-reduce. Omit the peer-to-peer communication over in pipeline parallel since it is negligible compared to the all-reduce operation of tensor parallel.

### 2.8.2 Batching Analysis

Batching is important in decoding. It significantly affects the latency and throughput. Batch size represents how many requests are processed in one forward pass, and larger batch sizes can amortize the cost of transferring weights, thus improving the throughput.

Global and micro-batch size. In distributed inference such as multi-GPU settings, define the global batch size b as the number of requests being actively processed by the whole cluster. It is a tunable hyper-parameter that represents the overall workload of the system. It is bounded by the maximal batch size, which is determined by the memory budget. On the other side, the micro batch size is defined at the device level as the batch size processed during each forward pass. Tensor parallelism does not affect the batch size while DP and PP shrink the micro batch size.

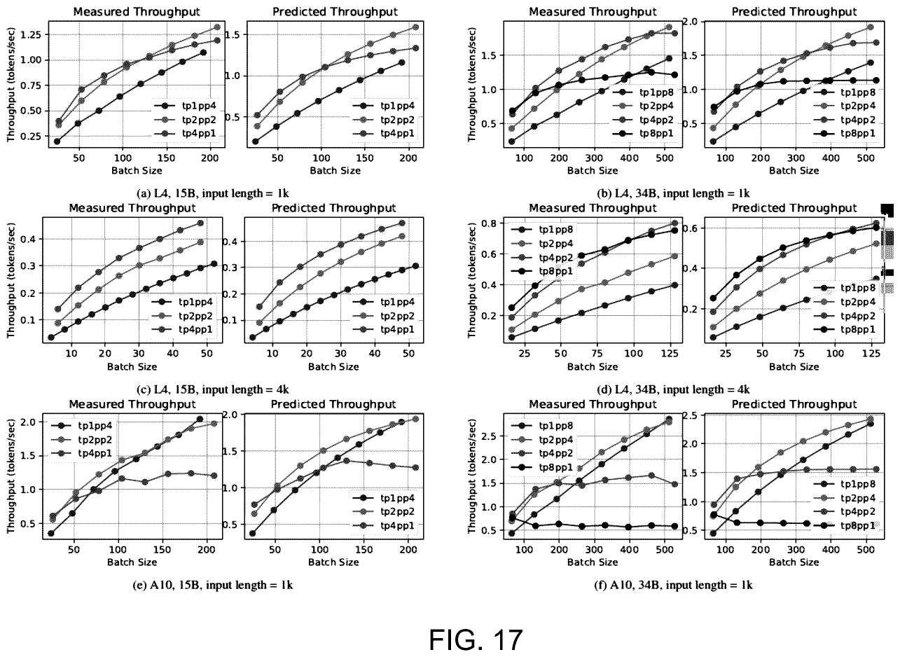

Referring to FIG. 17, a comparison between the measured decoding throughput and the predicted value given by our analytical model under different input lengths, GPU models, LLMs and parallelisms, is shown. The measured throughput is obtained by projecting the measured runtime for a single-layer, and the actual batch size can be much smaller than shown in the figure. HBM efficiency coefficient 0.8, FLOPS efficiency coefficient 0.5 for L4 and 0.6 for A10 are used.

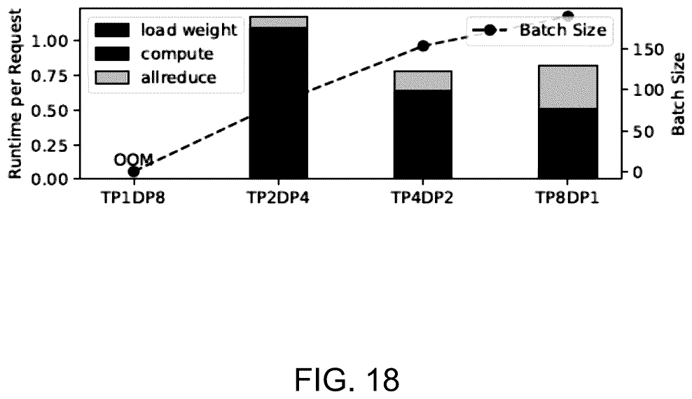

FIG. 18 shows how data parallelism affects the decoding throughput. Data parallelism has minimal communication overhead but suffers from caused by inefficient memory access caused by duplicating model weights. Model duplicates occupy more GPU memory, leaving less space for KV cache and smaller batch sizes. With more data parallelism, the overhead of loading data from GPU global memory to compute units significantly increases.

### 2.8.3 Parallelism Analysis

Consider three types of parallelism: data parallelism, tensor parallelism, and pipeline parallelism, and denote their degree of parallelism as DP, TP, and PP respectively.

Tensor parallelism can accelerate both data moving

$$( {T}_{dm}^{linear} and {T}_{dm}^{attn} are reduced to 1 / TP )$$

and computation T_{comp} (reduced to T_{comp}/TP), at the cost of all reduce overhead T_{nw}.

Data parallelism distributes the global batch size b onto DP micro-batches processed in parallel. The model is duplicated so

$${T}_{dm}^{linear}$$

remains unchanged.

$${T}_{dm}^{attn} , {T}_{comp}^{linear} , {T}_{comp}^{attn} ,$$

T_{nw} are reduced as the batch size is smaller. Due to the need to duplicate model weights, the GPU memory left for the KV cache is smaller. The spare space for KV cache on each GPU is:

$${M}_{k υ} = M - \frac{2 LW}{TP \cdot PP} .$$

The maximal batch size is:

$${b}_{max} = DP \cdot \frac{{M}_{k υ} \cdot TP \cdot PP}{4 {LH}_{k υ} ds} = DP \cdot \frac{M \cdot TP \cdot PP - 2 LW}{4 {LH}_{k υ} ds}$$

While TP and PP can super-linearly scale the batch size, DP can only linearly scale the batch size. The trade-off between limited batch sizes and reduced communication overhead is shown in FIG. 18.

Pipeline parallelism distributes different layers to different devices, and each device will have L/PP layers. It cannot reduce single-request latency but is more suitable for throughput-oriented scenarios as it introduces less communication overhead. However, it is not the ultimate answer of high-throughput applications because of an important observation that pipeline parallelism harms maximal batch size. A tricky nuance is that given a batch size b, pipeline parallelism can only process b/PP of them simultaneously in order to utilize and pipeline all PP GPUs, which is harmful to batching. If the workload is not uniformly distributed across GPUs, there will be bubbles, or in the worst case, some GPUs might be idle. When the pipeline is fully and stably pipelining, each time the last pipeline stage finishes its L/PP layers of forward pass, a micro-batch of b/PP will be finished.

Throughput. The micro-batch size on each GPU is b/(PP·DP). The total runtime of generating one micro batch with size b/(PP·DP) on one DP replica (or more specifically, the time of the last pipeline stage finishing a micro-batch) is:

$${T}_{stage} = \frac{L}{PP} \cdot [ max ( \frac{{T}_{dm}^{linear}}{TP} , \frac{{T}_{comp}^{linear}}{DP \cdot TP \cdot PP} ) + \frac{max ( {T}_{dm}^{attn} , {T}_{comp}^{attn} )}{DP \cdot TP \cdot PP} + \frac{{T}_{nw} ( TP )}{PP \cdot DP} ]$$

The throughput (number of processed requests per unit time) is b/PP/T. For simplicity, calculate the inverse of it as:

$${throughput}^{- 1} = \frac{{T}_{stage}}{b / PP} = \frac{L}{b} \cdot [ max ( \frac{{T}_{dm}^{linear}}{TP} , \frac{{T}_{comp}^{linear}}{DP \cdot TP \cdot PP} ) + \frac{max ( {T}_{dm}^{attn} , {T}_{comp}^{attn} )}{DP \cdot TP \cdot PP} + \frac{{T}_{nw} ( TP )}{PP \cdot DP} ] \qquad ( 1 )$$

If one approximates the roof-line model with a simplified additional model, this expression can be simplified as:

$${throughput}^{- 1} ∝ \frac{{T}_{dm}^{linear}}{TP} + \frac{{T}_{comp}^{linear} + {T}_{dm}^{attn} + {T}_{comp}^{attn}}{DP \cdot TP \cdot PP} + \frac{{T}_{nw} ( TP )}{PP \cdot DP} \qquad ( 2 )$$

### 2.8.4 Examples

Compare the predicted decoding throughput from our analytical model with real-world measurements. Since kernels typically fall short of achieving maximum utilization of HBM bandwidth or FLOPS, a scaling coefficient below one is applied to the corresponding parameters in the equation to better match observed performance. The results are shown in FIG. 17.

The analysis is intended not to predict final performance precisely, but rather to illustrate the general scaling trends of different parallelism strategies. When the global batch size is small, tensor parallelism is often advantageous, as pipeline parallelism can over-partition the batches into excessively small micro-batches, reducing batching efficiency. However, with larger batch sizes, increased PP becomes preferable, as it helps reduce communication overhead.

This phenomenon is more pronounced on the A10, as it has a similar interconnection bandwidth to the L4 but offers superior single-GPU performance. Additionally, with shorter sequence lengths, which lead to larger batch sizes, decoding becomes more compute-intensive, causing the shift from tensor parallelism (TP) to pipeline parallelism (PP) to occur earlier.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as transitory or non-transitory storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory computer readable medium which can be used to store the desired information and which can be accessed by an application, module, or both. Any such computer storage media may be part of the computing environment 10, any component of or related thereto, etc., or accessible or connectable thereto. Any application or module herein described may be implemented using computer readable/executable instructions that may be stored or otherwise held by such computer readable media.

The steps or operations in the flow charts and diagrams described herein are provided by way of example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as having regard to the appended claims in view of the specification as a whole.

### REFERENCES

Achiam, J., Adler, S., Agarwal, S., Ahmad, L., Akkaya, I., Aleman, F. L., Almeida, D., Altenschmidt, J., Altman, S., Anadkat, S., et al. Gpt-4 technical report. arXiv preprint arXiv: 2303.08774, 2023.
Agrawal, A., Panwar, A., Mohan, J., Kwatra, N., Gulavani, B. S., and Ramjee, R. Sarathi: Efficient Ilm inference by piggybacking decodes with chunked prefills. arXiv preprint arXiv: 2308.16369, 2023.
Agrawal, A., Kedia, N., Panwar, A., Mohan, J., Kwatra, N., Gulavani, B. S., Tumanov, A., and Ramjee, R. Taming throughput-latency tradeoff in Ilm inference with sarathiserve. arXiv preprint arXiv: 2403.02310, 2024.
Ainslie, J., Lee-Thorp, J., de Jong, M., Zemlyanskiy, Y., Lebr'on, F., and Sanghai, S. Gqa: Training generalized multi-query transformer models from multi-head checkpoints. arXiv preprint arXiv: 2305.13245, 2023.
AlbanD. Why not multiprocess pin memory in data loader? https://discuss.pytorch.org/t/why-notmultiprocess-pin-memory-in-data-loader/197345/2, 2023. Accessed: 2024 Oct. 14.
Amazon Web Services. Amazon EC2 Instance Types, 2024. URL https://aws.amazon.com/ec2/instance-types/. Accessed: 2024 Oct. 26.
Ben-Nun, T. and Hoefler, T. Demystifying parallel and distributed deep learning: An in-depth concurrency analysis. ACM Computing Surveys (CSUR), 52 (4): 1-43, 2019.
Bengio, Y., Ducharme, R., and Vincent, P. A neural probabilistic language model. Advances in neural information processing systems, 13, 2000.
Borzunov, A., Baranchuk, D., Dettmers, T., Ryabinin, M., Belkada, Y., Chumachenko, A., Samygin, P., and Raffel, C. Petals: Collaborative inference and fine-tuning of large models. arXiv preprint arXiv: 2209.01188, 2022.
Brandon, W., Nrusimha, A., Qian, K., Ankner, Z., Jin, T., Song, Z., and Ragan-Kelley, J. Striped attention: Faster ring attention for causal transformers. arXiv preprint arXiv: 2311.09431, 2023.
Chan, V., Zhang, H., and Wang, F. Snowflake Ilm inference: Optimizing gpu capacity for interactive workloads. https://www.snowflake.com/engineeringblog/snowflake-Ilm-inference-interactive-workloads/, September 2024. Accessed: 2024 Oct. 30.
Chang, L., Bao, W., Hou, Q., Jiang, C., Zheng, N., Zhong, Y., Zhang, X., Song, Z., Jiang, Z., Lin, H., et al. Flux: Fast software-based communication overlap on gpus through kernel fusion. arXiv preprint arXiv: 2406.06858, 2024.
Cheng, K., Hu, W., Wang, Z., Peng, H., Li, J., and Zhang, S. Slice-level scheduling for high throughput and load balanced Ilm serving. arXiv preprint arXiv: 2406. 13511, 2024.
Cohan, A., Dernoncourt, F., Kim, D. S., Bui, T., Kim, S., Chang, W., and Goharian, N. A discourse-aware attention model for abstractive summarization of long documents, arXiv preprint arXiv: 1804.05685, 2018.
Dell Technologies. Poweredge server gpu matrix, 2023. URL https://www.delltechnologies.com/asset/en-ca/products/servers/briefs-summaries/poweredge-server-gpu-matrix.pdf. Accessed: 2024 Oct. 24.
Dell Technologies. Inferencing performance for generative ai in the enterprise with amd accelerators. https://infohub.delltechnologies.com/en-au/l/generativeai-in-the-enterprise-with-amd-accelerators/inferencingperformance/, 2024. Accessed: 2024 Oct. 30.
Du, J., Wei, J., Jiang, J., Cheng, S., Huang, D., Chen, Z., and Lu, Y. Liger: Interleaving intra- and inter-operator parallelism for distributed large model inference. In Proceedings of the 29th ACM SIGPLAN Annual Symposium on Principles and Practice of Parallel Programming, pp. 42-54, 2024.
Edge, D., Trinh, H., Cheng, N., Bradley, J., Chao, A., Mody, A., Truitt, S., and Larson, J. From local to global: A graph rag approach to query-focused summarization. arXiv preprint arXiv: 2404.16130, 2024.
Elinas. Llama-3-15b instruct-zeroed. https://huggingface.co/elinas/Llama-3-15B-Instruct-zeroed, 2024.
Fang, J., Yu, Y., Zhao, C., and Zhou, J. Turbotransformers: an efficient gpu serving system for transformer models. In Proceedings of the 26th ACM SIGPLAN Symposium on Principles and Practice of Parallel Programming, pp. 389-402, 2021.
Google Cloud. GPU platforms: A100 GPUs, 2024. URL https://cloud.google.com/compute/docs/gpus#a100-gpus. Accessed: 2024 Oct. 26.
He, J. and Zhai, J. Fastdecode: High-throughput gpuefficient Ilm serving using heterogeneous pipelines. arXiv preprint arXiv: 2403.11421, 2024.
Holmes, C., Tanaka, M., Wyatt, M., Awan, A. A., Rasley, J., Rajbhandari, S., Aminabadi, R. Y., Qin, H., Bakhtiari, A., Kurilenko, L., et al. Deepspeed-fastgen: High-throughput text generation for Ilms via mii and deepspeed-inference. arXiv preprint arXiv: 2401.08671, 2024.
Hu, C., Huang, H., Xu, L., Chen, X., Xu, J., Chen, S., Feng, H., Wang, C., Wang, S., Bao, Y., et al. Inference without interference: Disaggregate Ilm inference for mixed downstream workloads. arXiv preprint arXiv: 2401.11181, 2024.
Huang, Y., Cheng, Y., Bapna, A., Firat, O., Chen, D., Chen, M., Lee, H., Ngiam, J., Le, Q. V., Wu, Y., et al. Gpipe: Efficient training of giant neural networks using pipeline parallelism. Advances in neural information processing systems, 32, 2019.
Jiang, Y., Yan, R., Yao, X., Zhou, Y., Chen, B., and Yuan, B. Hexgen: Generative inference of large language model over heterogeneous environment. In Forty-first International Conference on Machine Learning, 2023.
Jin, Y., Wang, T., Lin, H., Song, M., Li, P., Ma, Y., Shan, Y., Yuan, Z., Li, C., Sun, Y., et al. P/d-serve: Serving disaggregated large language model at scale. arXiv preprint arXiv: 2408.08147, 2024.
Kamahori, K., Gu, Y., Zhu, K., and Kasikci, B. Fiddler: Cpu-gpu orchestration for fast inference of mixture-ofexperts models. arXiv preprint arXiv: 2402.07033, 2024.
Kamsetty, A., Chen, H., and Xie, L. How bytedance scales offline inference with multi-modal Ilms to 200tb data. https://www.anyscale.com/blog/how-bytedance-scalesoffline-inference-with-multi-modal-Ilms-to-200 TB-data, August 2023. Accessed: 2024 Oct. 30.
Kwon, W., Li, Z., Zhuang, S., Sheng, Y., Zheng, L., Yu, C. H., Gonzalez, J., Zhang, H., and Stoica, I. Efficient memory management for large language model serving with paged attention. In Proceedings of the 29th Symposium on Operating Systems Principles, pp. 611-626, 2023.
Li, S., Xue, F., Baranwal, C., Li, Y., and You, Y. Sequence parallelism: Long sequence training from system perspective. arXiv preprint arXiv: 2105.13120, 2021.
Li, Z., Zheng, L., Zhong, Y., Liu, V., Sheng, Y., Jin, X., Huang, Y., Chen, Z., Zhang, H., Gonzalez, J. E., et al. {AlpaServe}: Statistical multiplexing with model parallelism for deep learning serving. In 17th USENIX Symposium on Operating Systems Design and implementation (OSDI 23), pp. 663-679, 2023.
Lin, B., Peng, T., Zhang, C., Sun, M., Li, L., Zhao, H., Xiao, W., Xu, Q., Qiu, X., Li, S., et al. Infinite-Ilm: Efficient Ilm service for long context with distattention and distributed kvcache. arXiv preprint arXiv: 2401.02669, 2024.
Liu, H., Zaharia, M., and Abbeel, P. Ring attention with blockwise transformers for near-infinite context. arXiv preprint arXiv: 2310.01889, 2023.
Liu, S., Biswal, A., Cheng, A., Mo, X., Cao, S., Gonzalez, J. E., Stoica, I., and Zaharia, M. Optimizing Ilm queries in relational workloads. arXiv preprint arXiv: 2403.05821, 2024.
Mei, Y., Zhuang, Y., Miao, X., Yang, J., Jia, Z., and Vinayak, R. Helix: Distributed serving of large language models via max-flow on heterogeneous gpus. arXiv preprint arXiv: 2406.01566, 2024.
Miao, X., Oliaro, G., Zhang, Z., Cheng, X., Jin, H., Chen, T., and Jia, Z. Towards efficient generative large language model serving: A survey from algorithms to systems. arXiv preprint arXiv: 2312.15234, 2023.
Miao, X., Shi, C., Duan, J., Xi, X., Lin, D., Cui, B., and Jia, Z. Spotserve: Serving generative large language models on preemptible instances. In Proceedings of the 29th ACM International Conference on Architectural Support for Programming Languages and Operating Systems, Volume 2, pp. 1112-1127, 2024.
MLCommons. MIperf inference: Datacenter benchmark suite. https://mlcommons.org/benchmarks/inference-datacenter/, 2024. Accessed: 2024 Oct. 30.
Narayan, A., Chami, I., Orr, L., Arora, S., and R′e, C. Can foundation models wrangle your data? arXiv preprint arXiv: 2205.09911, 2022.
Narayanan, D., Harlap, A., Phanishayee, A., Seshadri, V., Devanur, N. R., Ganger, G. R., Gibbons, P. B., and Zaharia, M. Pipedream: Generalized pipeline parallelism for dnn training. In Proceedings of the 27th ACM symposium on operating systems principles, pp. 1-15, 2019.
NVIDIA. Fastertransformer: Transformer related optimization, including bert, gpt. https://github.com/NVIDIA/FasterTransformer, 2024a.
NVIDIA. Tensorrt-Ilm: Optimized inference for large language models. https://github.com/NVIDIA/TensorRT-LLM, 2024b.
NVIDIA Corporation. Nvidia a100 pcie product brief, 2020. URL https://www.nvidia.com/content/dam/en-zz/Solutions/Data-Center/a100/pdf/A100-PCIE-Prduct-Brief.pdf. Accessed: 2024 Oct. 24.
NVIDIA Corporation. NVIDIA NVLink: High-Speed GPU Interconnect, 2024. URL https://www.nvidia.com/en-us/data-center/nvlink/. Accessed: 2024 Oct. 26.
OpenAI. Chatgpt (gpt-4), 2024. URL https://www.openai.com/research/gpt-4. Accessed: 2024 Aug. 2.
Pan, X., Li, E., Li, Q., Liang, S., Shan, Y., Zhou, K., Luo, Y., Wang, X., and Zhang, J. Instinfer: In-storage attention offloading for cost-effective long-context Ilm inference. arXiv preprint arXiv: 2409.04992, 2024.
Patel, P., Choukse, E., Zhang, C., Shah, A., Goiri, 'I., Maleki, S., and Bianchini, R. Splitwise: Efficient generative Ilm inference using phase splitting. In 2024 ACM/IEEE 51^{st} Annual International Symposium on Computer Architecture (ISCA), pp. 118-132. IEEE, 2024.
PCI-SIG. PCI-SIG Releases PCIe 4.0, Version 1.0, 2017. URL https://pcisig.com/pci-sig-releases-pcie % C2% AE-40-version-10.
Pope, R., Douglas, S., Chowdhery, A., Devlin, J., Bradbury, J., Heek, J., Xiao, K., Agrawal, S., and Dean, J. Efficiently scaling transformer inference. Proceedings of Machine Learning and Systems, 5:606-624, 2023.
Qin, R., Li, Z., He, W., Zhang, M., Wu, Y., Zheng, W., and Xu, X. Mooncake: Kimi's kvcache-centric architecture for Ilm serving. arXiv preprint arXiv: 2407.00079, 2024.
Rajbhandari, S., Rasley, J., Ruwase, O., and He, Y. Zero: Memory optimizations toward training trillion parameter models. In SC20: International Conference for High Performance Computing, Networking, Storage and Analysis, pp. 1-16. IEEE, 2020.
Ren, J., Rajbhandari, S., Aminabadi, R. Y., Ruwase, O., Yang, S., Zhang, M., Li, D., and He, Y. {Zero-offload}: Democratizing {billion-scale} model training. In 2021 USENIX Annual Technical Conference (USENIX ATC 21), pp. 551-564, 2021.
Roziere, B., Gehring, J., Gloeckle, F., Sootla, S., Gat, I., Tan, X. E., Adi, Y., Liu, J., Sauvestre, R., Remez, T., et al. Code llama: Open foundation models for code. arXiv preprint arXiv: 2308.12950, 2023.
ShareGPT. Sharegpt vicuna unfiltered dataset. https://huggingface.co/datasets/anon8231489123/ShareGPT_Vicuna_unfiltered, 2023. Apache 2.0 License.
Sheng, Y., Zheng, L., Yuan, B., Li, Z., Ryabinin, M., Chen, B., Liang, P., R′e, C., Stoica, I., and Zhang, C. Flexgen: High-throughput generative inference of large language models with a single gpu. In International Conference on Machine Learning, pp. 31094-31116. PMLR, 2023.
Shoeybi, M., Patwary, M., Puri, R., LeGresley, P., Casper, J., and Catanzaro, B. Megatron-Im: Training multibillion parameter language models using model parallelism. arXiv preprint arXiv: 1909.08053, 2019.
Song, Y., Mi, Z., Xie, H., and Chen, H. Powerinfer: Fast large language model serving with a consumer-grade gpu. arXiv preprint arXiv: 2312.12456, 2023.
Srivatsa, V., He, Z., Abhyankar, R., Li, D., and Zhang, Y. Preble: Efficient distributed prompt scheduling for Ilm serving. 2024.
Touvron, H., Lavril, T., Izacard, G., Martinet, X., Lachaux, M.-A., Lacroix, T., Rozi ere, B., Goyal, N., Hambro, E., Azhar, F., et al. Llama: Open and efficient foundation language models. arXiv preprint arXiv: 2302.13971, 2023a.
Touvron, H., Martin, L., Stone, K., Albert, P., Almahairi, A., Babaei, Y., Bashlykov, N., Batra, S., Bhargava, P., Bhosale, S., et al. Llama 2: Open foundation and finetuned chat models. arXiv preprint arXiv: 2307.09288, 2023b.
Vaswani, A., Shazeer, N., Parmar, N., Uszkoreit, J., Jones, L., Gomez, A. N., Kaiser, Ł., and Polosukhin, I. Attention is all you need. Advances in neural information processing systems, 30, 2017.
vLLM Team. Performance update: Bringing vllm to the next level. https://blog.vllm.ai/2024/09/05/perf-update.html, 2024. Accessed: 2024 Oct. 14.
Xuanlei, Z., Jia, B., Zhou, H., Liu, Z., Cheng, S., and You, Y. Hetegen: Efficient heterogeneous parallel inference for large language models on resource-constrained devices. Proceedings of Machine Learning and Systems, 6:162-172, 2024.
Xue, F., Chen, Y., Li, D., Hu, Q., Zhu, L., Li, X., Fang, Y., Tang, H., Yang, S., Liu, Z., et al. Longvila: Scaling longcontext visual language models for long videos. arXiv preprint arXiv: 2408.10188, 2024.
Yu, C., Lee, S., Xu, R., Lin, W., Gorthy, P., and Liaw, R. Batch Ilm inference on anyscale slashes aws bedrock costs by up to 6×, October 2024. URL https://www.anyscale.com/blog/batch-Ilm-inference-announcement. Accessed: 2024 Oct. 30.
Yu, G.-I., Jeong, J. S., Kim, G.-W., Kim, S., and Chun, B.-G. Orca: A distributed serving system for {Transformer-Based} generative models. In 16th USENIX Symposium on Operating Systems Design and Implementation (OSDI 22), pp. 521-538, 2022.
Yuan, Z., Shang, Y., Zhou, Y., Dong, Z., Xue, C., Wu, B., Li, Z., Gu, Q., Lee, Y. J., Yan, Y., et al. LIm inference unveiled: Survey and roofline model insights. arXiv preprint arXiv: 2402. 16363, 2024.
Zhao, J., Wan, B., Peng, Y., Lin, H., and Wu, C. LImpq: Serving Ilm on heterogeneous clusters with phaseaware partition and adaptive quantization. arXiv preprint arXiv: 2403.01136, 2024.
Zhao, Y., Gu, A., Varma, R., Luo, L., Huang, C.-C., Xu, M., Wright, L., Shojanazeri, H., Ott, M., Shleifer, S., et al. Pytorch fsdp: experiences on scaling fully sharded data parallel. arXiv preprint arXiv: 2304.11277, 2023.
Zheng, L., Li, Z., Zhang, H., Zhuang, Y., Chen, Z., Huang, Y., Wang, Y., Xu, Y., Zhuo, D., Xing, E. P., et al. Alpa: Automating inter- and {Intra-Operator} parallelism for distributed deep learning. In 16th USENIX Symposium on Operating Systems Design and Implementation (OSDI 22), pp. 559-578, 2022.
Zheng, L., Yin, L., Xie, Z., Huang, J., Sun, C., Yu, C. H., Cao, S., Kozyrakis, C., Stoica, I., Gonzalez, J. E., et al. Efficiently programming large language models using sglang. arXiv preprint arXiv: 2312.07104, 2023.
Zhong, Y., Liu, S., Chen, J., Hu, J., Zhu, Y., Liu, X., Jin, X., and Zhang, H. Distserve: Disaggregating prefill and decoding for goodput-optimized large language model serving. arXiv preprint arXiv: 2401.09670, 2024.
Zhu, K., Zhao, Y., Zhao, L., Zuo, G., Gu, Y., Xie, D., Gao, Y., Xu, Q., Tang, T., Ye, Z., et al. Nanoflow: Towards optimal large language model serving throughput. arXiv preprint arXiv: 2408.12757, 2024.

1. A method of executing a deep learning workload, the method comprising:
selecting, by a processor, at least one parallelization strategy for a first processing stage of the deep learning workload;
selecting, by the processor, at least one different parallelization strategy for a second processing stage of the deep learning workload; and
switching, by the processor, between the different parallelization strategies used for the first processing stage and the second processing stage by reconfiguring a partitioning of the deep-learning workload across computing resources.

2. The method of claim 1, wherein reconfiguring the partitioning of the deep-learning workload comprises dynamically re-sharding one or more model parameters across the computing resources.

3. The method of claim 1, wherein reconfiguring the partitioning further comprising using tiered key-value cache buffering to reduce re-sharding overheads.

4. The method of claim 3, wherein using tiered key-value cache further comprising:
buffering key-value cache data in a tiered memory hierarchy including a primary storage and an auxiliary storage; and
controlling the switching between the parallelization strategies based on a storage state of the key-value cache in the auxiliary storage.

5. The method of claim 4, wherein the auxiliary storage is a shared memory on a secondary device.

6. The method of claim 1, wherein the deep learning workload includes large language model (LLM) inference.

7. The method of claim 6, wherein the first processing stage is prefilling stage of LLM inference and the at least one parallelization strategy selected for the first processing stage is pipeline parallelism, and wherein the second processing stage is decoding stage and the at least one different parallelization strategy for the second processing stage is tensor parallelism.

8. The method of claim 1, wherein the parallelization strategies utilize multiple computing resources, including any one or more of graphics processing units (GPUs), CPUs, or accelerators.

9. The method of claim 1, wherein switching between the different parallelization strategies further comprising applying a transition-minimizing scheduling policy.

10. The method of claim 9, wherein the transition-minimizing scheduling policy is configured to control the switching between the first and second processing stages to occur when a key-value cache in an auxiliary storage is either full or empty.

11. The method of claim 1, wherein the method is performed by a deep-learning workload execution engine comprising a single-scheduler, multi-worker design, and wherein the single scheduler manages generation requests, organizes the generation requests into batches, and sends instructions to a plurality of workers.

12. The method of claim 1, further comprising, during execution of the deep-learning workload, using an asynchronous pipeline to overlap key-value cache transfer with ongoing computation.

13. The method of claim 1, wherein the deep-learning workload includes one or more time-varying compute characteristics.

14. A computer readable medium storing computer-executable instructions for performing the method of claim 1.

15. A deep-learning workload execution engine comprising a processor and memory, the memory storing computer-executable instructions that, when executed by the processor, cause the deep-learning workload execution engine to perform the steps of:
selecting at least one parallelization strategy for a first processing stage of the deep learning workload;
selecting at least one different parallelization strategy for a second processing stage of the deep learning workload; and
switching between the different parallelization strategies used for the first processing stage and the second processing stage by reconfiguring a partitioning of the deep-learning workload across computing resources.

16. The engine of claim 15, wherein reconfiguring the partitioning of the deep-learning workload comprises dynamically re-sharding one or more model parameters across the computing resources.

17. The engine of claim 15, comprising an interconnected and distributed configuration.

18. The engine of claim 15, wherein the deep learning workload includes large language model (LLM) inference and wherein:
the first processing stage is prefilling stage of LLM inference and the at least one parallelization strategy selected for the first processing stage is pipeline parallelism, and
the second processing stage is decoding stage and the at least one different parallelization strategy for the second processing stage is tensor parallelism.

19. The engine of claim 15, wherein reconfiguring the partitioning further comprising using tiered key-value cache buffering to reduce re-sharding overheads.

20. The engine of claim 19, wherein using tiered key-value cache further comprising:
buffering key-value cache data in a tiered memory hierarchy including a primary storage and an auxiliary storage; and
controlling the switching between the parallelization strategies based on a storage state of the key-value cache in the auxiliary storage.
